(19) United States
(12) Patent Application Publication
(10) Pub. No.: US 2025/0064065 A1
(43) Pub. Date: Feb. 27, 2025

(54) BIOSTIMULANT FOR ENHANCING OF CURCUMA LONGA GROWTH AND SECONDARY METABOLITE PRODUCTION

(71) Applicant: KING FAISAL UNIVERSITY, Al-Ahsa (SA)

(72) Inventors: FADIA EL SHERIF, Al-Ahsa (SA); SALAH KHATTAB, Al-Ahsa (SA); ALAA AHMED ALI ALAMER, Al-Ahsa (SA); YUN KIAM YAP, Al-Ahsa (SA)

(21) Appl. No.: 18/238,162

(22) Filed: Aug. 25, 2023

(51) Int. Cl. A01N 65/42; A01P 21/00

(52) U.S. Cl. CPC A01N 65/42; A01P 21/00

(57) ABSTRACT

Methods for stimulating the growth, yield, and secondary metabolite production of Curcuma longa plants are provided. Administration of between about 10 ml/L and about 40 ml/L Aloe vera extract to Curcuma longa plants results in increased plant growth, rhizome production, and production of secondary metabolites including curcuminoids.

### BACKGROUND

### 1. Field

The disclosure of the present patent application relates to compositions and methods for administering a biostimulant to Curcuma longa, and particularly to compositions and methods for administering Aloe vera extract to enhance Curcuma longa growth and production of secondary metabolites by Curcuma longa.

### DESCRIPTION OF THE PRIOR ART

The use of chemical fertilizers and pesticides to increase crop growth and yield have further aggravated crop production problems as they have led to nitrate pollution of the ground water, nutrient imbalance of the soil, and short- and/or long-term health threats to the whole biosphere. In view of this, the development of bio-stimulants has gaining popularity over recent decades. A plant bio-stimulant is defined as any substance or microorganism, which is applied to plants with the aim to increase their nutrition efficiency, abiotic stress tolerance and/or crop quality traits. Plant extracts are among the several categories of bio-stimulants.

Aloe vera is a perennial plant with thick leaves. Its leaves contain parenchyma cells with a transparent mucilaginous jelly referred to as Aloe vera gel. Aloe vera gel is rich in minerals (e.g., calcium, iron, magnesium, potassium, phosphorus, and zinc), enzymes (e.g., amylase, catalase, lipase, oxidase and superoxide dismutase), amino acids (e.g., alanine, glycine, leucine, and proline), vitamins (e.g., B-complex, C, β-carotene, and α-tocopherol), and phytohormones (e.g., gibberellin, indoleacetic acetic, and abscisic acid). Application of water diluted cold press Aloe vera gel as a bio-stimulant has been reported in several plant species.

The underground portion of Curcuma longa contains the rhizomes, which are used as spices and as traditional therapeutic remedies. Curcuminoid is a phenolic compound composed of curcumin and its derivatives, dimethoxy curcumin and bis-demethoxy curcumin found in the rhizomes. Curcuminoid has been implicated in the antioxidant, anti-inflammatory, antimutagenic, antimicrobial, and anticancer activities of turmeric extracts.

Curcumin is characterized by a comprehensive range of biological, medicinal, and pharmacological activities. Curcumin has been demonstrated to have antioxidant, antimicrobial, anti-malarial, anticancer, anti-thrombotic, anti-hyperlipidemic, hypoglycemic, anti-inflammatory, anti-rheumatic, and myocardial infarction protective activities.

Thus, compositions and methods to solve the aforementioned problems are desired.

### SUMMARY

The present subject matter relates to the use of Aloe vera extracts as biostimulants to increase the growth and secondary metabolite production of Curcuma longa.

Accordingly, in one embodiment, the present subject matter relates to a method of administering a biostimulant composition comprising Aloe vera extract to Curcuma longa to increase the growth of Curcuma longa. The Aloe vera extract may be Aloe vera leaf extract and it may be administered by foliar spraying. The administration of the Aloe vera extract may result in increased plant height, number of leaves and roots, and dry weight of leaves and roots.

In another embodiment, the present subject matter relates to a method of administering a biostimulant composition comprising Aloe vera extract to Curcuma longa to increase the rhizome production of Curcuma longa. The Aloe vera extract may be Aloe vera leaf extract and it may be administered by foliar spraying. The administration of the Aloe vera extract may result in an increase in the number of rhizomes, diameter of rhizomes, dry weight of leaves, dry weight of roots, and dry weight of rhizomes of the Curcuma longa.

In a further embodiment, the present subject matter relates to a method of administering a biostimulant composition comprising Aloe vera extract to Curcuma longa to increase the secondary metabolite production of Curcuma longa. The Aloe vera extract may be Aloe vera leaf extract and it may be administered by foliar spraying. The administration of the Aloe vera extract may result in increased secondary metabolite production of Curcuma longa, including but not limited to production of bisdemethoxycurcumin, demethoxycurcumin, and curcumin.

These and other features of the present subject matter will become readily apparent upon further review of the following specification.

### DETAILED DESCRIPTION

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

“Subject” as used herein refers to any animal classified as a mammal, including humans, domestic and farm animals, and zoo, sports, and pet companion animals such as household pets and other domesticated animals such as, but not limited to, cattle, sheep, ferrets, swine or pigs, horses, camels, poultry, rabbits, goats, dogs, cats, and the like.

As used herein, the term “providing” an agent is used to include “administering” the agent to a subject.

As used herein, a “carrier” includes any and all solvents, dispersion media, vehicles, coatings, diluents, isotonic and absorption delaying agents, buffers, carrier solutions, suspensions, colloids, excipients, and the like.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

As used herein, the term “about”, when modifying a number, shall mean within a range of up to 10% above or below the modified value.

The present subject matter relates to the use of Aloe vera extracts as biostimulants to increase the growth and secondary metabolite production of Curcuma longa.

Accordingly, in an embodiment, the biostimulant composition comprises between about 10 ml/L and about 40 ml/L Aloe vera extract (ALE) diluted in distilled water. In another embodiment, the biostimulant composition comprises about 10 ml/L about 20 ml/L or about 40 ml/L ALE diluted in distilled water.

In an embodiment, the biostimulant composition may be administered to the Curcuma long plants by foliar spraying.

The biostimulant compositions described herein can be prepared by mixing ALE with distilled water. For example, the method of making a biostimulant composition herein can include obtaining Aloe vera gel by scraping leaves of an Aloe vera plant, blending the gel with a blender and filtering the blended gel using muslin cloth to obtain a gel solution (ALE). The ALE may be stored at 4° C. until use, or overnight.

The composition can be presented in a form suitable for daily, weekly, or monthly administration. The compositions herein can contain, per dosage unit, amounts of the active ingredients necessary to deliver an effective dose. Effective amounts of the ALE may be determined initially from the Examples described herein and adjusted for specific Curcuma longa growth conditions using routine methods.

In a further embodiment, the present subject matter relates to a method of administering a biostimulant composition comprising Aloe vera extract to Curcuma longa to increase the growth of Curcuma longa. The ALE may be Aloe vera leaf extract and it may be administered by foliar spraying. The administration of the ALE may result in an increase of at least one measure of plant growth selected from the group consisting of plant height, number of leaves and roots, and dry weight of leaves and roots.

The administration of ALE at about 10 ml/L may result in an increase in the number of roots of C. longa.

The administration of ALE at about 20 ml/L may result in an increase in the number of roots of C. longa.

The administration of ALE at about 40 ml/L may result in an increase in the shoot length, root length, number of roots, and number of leaves of C. longa.

In another embodiment, the present subject matter relates to a method of administering a biostimulant composition comprising Aloe vera extract to Curcuma longa to increase the rhizome production of Curcuma longa. The Aloe vera extract may be Aloe vera leaf extract and it may be administered by foliar spraying. The administration of the Aloe vera extract may result in increase in at least one metric selected from the group consisting of number of rhizomes, diameter of rhizomes, dry weight of leaves, dry weight of roots, and dry weight of rhizomes.

The administration of ALE at about 10 ml/L may result in an increase in the number of rhizomes and the diameter of the rhizomes of C. longa.

The administration of ALE at about 20 ml/L may result in an increase in the number of rhizomes and the dry weight of the rhizomes of C. longa.

The administration of ALE at about 40 ml/L may result in an increase in the number of rhizomes, the diameter of the rhizomes, the dry weight of leaves, the dry weight of roots, and the dry weight of rhizomes of C. longa.

In a further embodiment, the present subject matter relates to a method of administering a biostimulant composition comprising Aloe vera extract to Curcuma longa to increase the secondary metabolite production of Curcuma longa. The Aloe vera extract may be Aloe vera leaf extract and it may be administered by foliar spraying. The administration of the Aloe vera extract may result in increased secondary metabolite production of Curcuma longa, including but not limited to production of bisdemethoxycurcumin, demethoxycurcumin, and curcumin.

The administration of ALE at about 10 ml/L may result in an increase in the production of bisdemethoxycurcumin, demethoxycurcumin, and curcumin by C. longa.

The administration of ALE at about 20 ml/L may result in an increase in the production of bisdemethoxycurcumin, demethoxycurcumin, and curcumin by C. longa.

The administration of ALE at about 40 ml/L may result in an increase in the production of bisdemethoxycurcumin, demethoxycurcumin, and curcumin by C. longa.

The present subject matter may be further understood in view of the following examples.

### EXAMPLES

### Example 1

Aloe vera plants were purchased from agricultural nurseries. Aqueous Aloe vera leaf extract was prepared a day before the foliar treatment by obtaining A. vera gel from leaves cut from the Aloe vera plants and cold pressed to obtain a gel solution (El Sherif, “Aloe vera leaf extracts as a potential growth enhancer for Populus trees grown under in vitro conditions”, Am. J. Plant Biol. 2 (3): pp. 101-105, 2017). The gel solution was homogenized using a blender, filtered through muslin cloth, and stored at 4° C. overnight as an aqueous Aloe vera leaf extract (ALE). The ALE was diluted with distilled water into 3 different concentrations (10-, 20-, and 40 mL/L) right before foliar spray.

The effects of ALE treatments on Curcuma longa growth were assessed by measuring shoot length, root length, number of roots, and number of leaves of Curcuma longa plants treated with 10 ml/L, 20 ml/L, and 4 ml/L ALE. The results are summarized in Table 1.

TABLE 1

| | Shoot | Root | Number | Number |
|---|---|---|---|---|
| | length | length | of | of |
| Treatment | (cm) | (cm) | roots (n) | leaves (n) |
| Control | 97.50^{bc}* | 12.25^{cd} | 20.75^{d} | 9.50^{abc} |
| ALE 10 mL/L | 79.67^{c} | 11.33^{d} | 25.00^{cd} | 8.33^{bc} |
| ALE 20 mL/L | 84.67^{c} | 11.67^{d} | 20.33^{d} | 8.00^{c} |
| ALE 40 mL/L | 125.33^{a} | 16.00^{ab} | 38.00^{a} | 10.33^{ab} |

Superscripts indicate significant differences.

The effects of ALE treatments on Curcuma longa rhizome production were assessed by measuring number of rhizomes, rhizome diameter, dry weight of leaves, dry weight of roots, and dry weight of rhizomes of Curcuma longa plants treated with 10 ml/L, 20 ml/L, and 4 ml/L ALE. The results are summarized in Table 2.

TABLE 2

| | Number of | Rhizome's | Leaves | Roots | Rhizomes |
|---|---|---|---|---|---|
| | rhizomes | diam. | dry | dry | dry |
| Treatment | (n) | (mm) | weight (g) | weight (g) | weight (g |
| Control | 3.25^{c}* | 14.58^{b} | 9.60^{b} | 0.83^{c} | 11.35^{b} |
| ALE 10 mL/L | 4.67^{bc} | 17.87^{ab} | 5.27^{b} | 0.83^{c} | 9.33^{b} |
| ALE 20 mL/L | 4.33^{bc} | 13.78^{b} | 6.93^{b} | 0.73^{c} | 12.67^{b} |
| ALE 40 mL/L | 7.00^{ab} | 20.01^{ab} | 21.53^{a} | 2.23^{a} | 26.03^{a} |

Superscripts indicate significant differences.

The effects of ALE treatments on Curcuma longa secondary metabolite production were assessed by measuring the amount of bisdemethoxycurcumin, demethoxycurcumin, and curcumin produced by Curcuma longa plants treated with 10 ml/L, 20 ml/L, and 4 ml/L ALE. The results are summarized in Table 3.

TABLE 3

| | Bisdemethoxy- | Demethoxy- | |
|---|---|---|---|
| | curcumin | curcumin | Curcumin |
| Treatment | (ug/mL) | (ug/mL) | (ug/mL) |
| Control | 293.796^{d}* | 180.199^{e} | 617.604^{f} |
| ALE 10 mL/L | 486.848^{ab} | 441.888^{b} | 1177.286^{bc} |
| ALE 20 mL/L | 403.219^{bc} | 323.876^{d} | 961.607^{d} |
| ALE 40 mL/L | 553.019^{a} | 490.811^{a} | 1258.892^{a} |

Superscripts indicate significant differences.

As indicated in the results shown in Tables 1, 2 and 3, it was found that the application of Aloe vera leaf extract in concentrations ranging between 10 ml/L and 40 ml/L increased at least one metric of each of Curcuma longa growth, rhizome production, and secondary metabolite production. Further, treatment with about 40 mL/L ALE improved plant growth (increase in length of shoot and root, and number of roots and leaves), yield (increase in number of rhizomes, rhizome's diameter, and dried weight of leaves, roots, and rhizomes), and secondary metabolite production (including curcuminoids Bisdemethoxycurcumin, Demethoxycurcumin, and Curcumin).

It is to be understood that the biostimulant for enhancing Curcuma longa growth and secondary metabolite production is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method of enhancing growth of a Curcuma longa plant, the method comprising:
preparing an Aloe vera extract by a method consisting of:
obtaining an Aloe vera gel by scraping a leaf of an Aloe vera plant;
blending the Aloe vera gel with a blender to obtain a blended gel; and
filtering the blended gel with a muslin cloth to obtain the Aloe vera extract; and
administering a biostimulant to the Curcuma longa plant, wherein the biostimulant comprises the Aloe vera extract and wherein the administration of the biostimulant results in an increase in at least one measure of plant growth of the Curcuma longa plant due to the biostimulant's biostimulant activity.

2. The method of claim 1, comprising administering the biostimulant to the Curcuma longa plant by foliar spraying.

3. The method of claim 1, comprising administering between about 10 ml/L and about 40 ml/L Aloe vera extract to the Curcuma longa plant.

4. The method of claim 3, comprising administering about 40 ml/L Aloe vera extract to the Curcuma longa plant.

5. The method of claim 1, wherein the at least one measure of plant growth of the Curcuma longa plant is selected from the group consisting of shoot length, root length, number of roots, and number of leaves of the Curcuma longa plant.

6. A method of enhancing rhizome production of a Curcuma longa plant, the method comprising:
preparing an Aloe vera extract by a method consisting of:
obtaining an Aloe vera gel by of an Aloe vera plant;
blending the Aloe vera gel with a blender to obtain a blended gel; and
filtering the blended gel with a muslin cloth to obtain the Aloe vera extract; and
administering a biostimulant to the Curcuma longa plant, wherein the biostimulant comprises the Aloe vera extract and wherein the administration of the biostimulant results in an increase in at least one measure of rhizome production of the Curcuma longa plant due to the biostimulant's biostimulant activity.

7. The method of claim 6, comprising administering the biostimulant to the Curcuma longa plant by foliar spraying.

8. The method of claim 6, comprising administering between about 10 ml/L and about 40 ml/L Aloe vera extract to the Curcuma longa plant.

9. The method of claim 8, comprising administering about 40 ml/L Aloe vera extract to the Curcuma longa plant.

10. The method of claim 6, wherein the at least one measure of rhizome production of the Curcuma longa plant is selected from the group consisting of number of rhizomes, rhizome diameter, dry weight of leaves, dry weight of roots, and dry weight of rhizomes of the Curcuma longa plant.

11. A method of enhancing secondary metabolite production of a Curcuma longa plant, the method comprising:
preparing an Aloe vera extract by a method consisting of:
obtaining an Aloe vera gel by of an Aloe vera plant;
blending the Aloe vera gel with a blender to obtain a blended gel; and
filtering the blended gel with a muslin cloth to obtain the Aloe vera extract; and
administering a biostimulant to the Curcuma longa plant, wherein the biostimulant comprises the Aloe vera extract and wherein the administration of the biostimulant results in an increase in at least one measure of secondary metabolite production of the Curcuma longa plant due to the biostimulant's biostimulant activity.

12. The method of claim 11, comprising administering the biostimulant to the Curcuma longa plant by foliar spraying.

13. The method of claim 11, comprising administering between about 10 ml/L and about 40 ml/L Aloe vera extract to the Curcuma longa plant.

14. The method of claim 13, comprising administering about 40 ml/L Aloe vera extract to the Curcuma longa plant.

15. The method of claim 11, wherein the at least one measure of secondary metabolite production of the Curcuma longa plant is selected from the group consisting of bisdemethoxycurcumin, demethoxycurcumin, and curcumin production of the Curcuma longa plant.

16. The method of claim 1, wherein the administration of the biostimulant results in an increase in at least one measure of plant growth of the Curcuma longa plant, an increase in plant yield, and an increase in secondary metabolite production due to the biostimulant's biostimulant activity.
